(19) United States
(12) Patent Application Publication
(10) Pub. No.: US 2007/0203998 A1
(43) Pub. Date: Aug. 30, 2007

(54) Persistent instant messaging status indicators for disconnected communicators

(75) Inventors: Scott H. Demsky, Boca Raton, FL (US); William R. Ferguson, Boca Raton, FL (US)

Correspondence Address: PATENTS ON DEMAND, P.A., 4581 WESTON ROAD, SUITE 345, WESTON, FL, 33331, US

(73) Assignee: INTERNATIONAL BUSINESS MACHINES CORPORATION, Armonk, NY (US)

(21) Appl. No.: 11/362,462

(22) Filed: Feb. 24, 2006

(51) Int. Cl. G06F 15/16

(52) U.S. Cl. 709/207

(57) ABSTRACT

A method for instant messages can include a step of an instant messaging server receiving a status request for a user from a status requester. The instant messaging server can determine that the user is not connected to the instant messaging server. A status repository can be queried for an offline status indicator associated with the user. Responsive to finding an offline status indicator in the querying step, the offline status indicator can be conveyed to the status requester.

### BACKGROUND

1. Field of the Invention

The present invention relates to the field of instant messaging and, more particularly, to user configurable status indicators used when a user is offline or disconnected from an instant messaging server.

2. Description of the Related Art

Instant messaging is a form of electronic communication which involves immediate correspondence between two or more users who are all online simultaneously. Instant messaging systems utilize a client/server architecture. Most instant messaging services offer a presence information feature that indicates whether people on one's list of contacts (e.g. “Buddy List”) are currently online and available to chat.

Within a client application, each user can adjust values related to the presence information feature, which affect status information regarding the user that others see. Common values for a status indicator include “Active,” “Do Not Disturb,” and “Away from Desk.” When other communicators view the user's status via their contact list, or attempt to initiate an instant messaging session with the user, the status indicator is displayed.

If a user is not connected to an instant messaging server, then that user's status is indicated as “offline” in some fashion, such as graying out and disabling names on a buddy list associated with offline users. The offline status does not provide any useful information to others who desire to contact that user.

### SUMMARY OF THE INVENTION

The present invention includes a persistent instant messaging (IM) status, which permits users to establish one or more status indications and/or status parameters that are presented when that user is offline. More specifically, a user configured offline status indicator can be stored on an IM server and presented to communicators when the user is disconnected from the IM server. Consequently, an IM user can provide contact information or other relevant messages to IM communicators when offline. For example, a user can specify “I am offline until 2:00 P.M. EST—If necessary contact me at 234-2345.” This message can be presented to other IM communicators in place of a default offline indication.

In one embodiment, additional status parameters can be added to the offline status indicator. One such status parameter can include status time parameters for which the offline status indicator applies. For example, a user can specify that a customized status indicator is to be presented between 9:00 A.M. and 5:00 P.M. Outside this time window, default IM server behavior is to occur, such as providing a generic offline indication to potential IM communicators.

The present invention can be implemented in accordance with numerous aspects consistent with material presented herein. For example, one aspect of the present invention can include a method for instant messages. The method can include a step of an IM server receiving a status request for a user from a status requester. The IM server can determine that the user is not connected to the IM server. A status repository can be queried for an offline status indicator associated with the user. Responsive to finding an offline status indicator in the querying step, the offline status indicator can be conveyed to the status requester.

Another aspect of the present invention can include an IM interface. The IM interface can include an offline status indicator that is configurable by a user. The offline status indicator can be presented to status requesters seeking a status of the user when the user is offline.

Still another aspect of the present invention can include an IM server that has access to a status repository. The status repository can include user established offline status indicators. Each offline status indicator can be associated with an IM user. The IM server can be configured to present one of the user established offline status indicators to a status requester seeking a status of an associated IM user whenever the associated IM user is not connected to the IM server.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a system for persistent instant messaging (IM) status indicators in accordance with an embodiment of the inventive arrangements disclosed herein.

FIG. 2 illustrates IM graphical user interfaces (GUIs) for an IM system having persistent IM status indicators in accordance with an embodiment of the inventive arrangements disclosed herein.

FIG. 3 is a flow chart of a method for implementing persistent IM status indicators in accordance with an embodiment of the inventive arrangements disclosed herein.

### DETAILED DESCRIPTION OF THE INVENTION

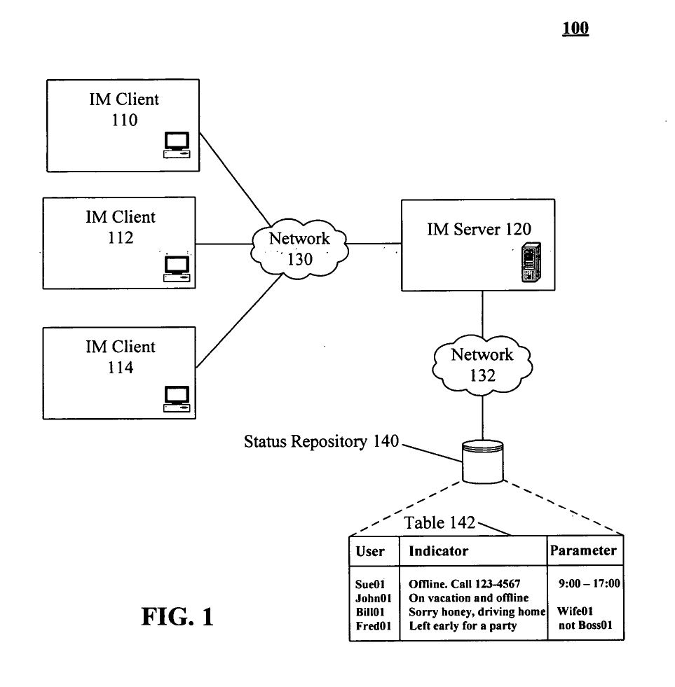

FIG. 1 is a schematic diagram of a system 100 for persistent instant messaging (IM) status indicators in accordance with an embodiment of the inventive arrangements disclosed herein. In system 100, IM clients 110, 112, and 114 can electronically communicate with each other in real-time or near-real time using instant messages. The IM communications can be facilitated by IM server 120. IM clients 110-114 and IM server 120 can be communicatively linked to each other via network 130.

IM server 120 can include a presence information feature or a status indicator, which generally indicates an IM user's availability status. This status can be communicated to the IM clients 110-114. The indicated status can be presented within a contact list, next to a user for whom the status applies. Additionally, each IM client 110-114 can include an ability to set a status for an IM user, which is displayed to other users. For example, common status indicators include: available; away from the computer; do not disturb; and disconnected.

Unlike conventional IM systems, system 100 provides an ability for an IM user to specify a status indicator related to a disconnected or offline state, referred to as an offline status indicator. In one embodiment, an IM user can also set one or more offline status parameters which conditionally determine how, when, and to whom a customized offline status indicator is presented. For example, an offline status parameter can establish a time range for displaying an offline status indicator. In another example, an offline status parameter can specify a set of IM users who are to receive the offline status indicator instead of a default system indication.

Unlike other status indicators, which can be retrieved from an IM client 110-114 upon request, the offline status indicator should be stored in a location remote from the IM client 110-114 from which it was defined. Remote storage is necessary because an IM server 120 is unable to query a client 110-114 for status information, when that client 110-114 is offline.

Accordingly, an IM user can specify an offline status indicator as well as one or more offline status parameters within an interface of IM client 110-114. The indicator can be conveyed to IM server 120, and stored in status repository 140. Whenever a status indication is requested for an offline IM user, the IM server 120 can query the status repository 140 to determine if a customized status indicator should be provided.

For example, table 142 can include a listing of stored offline status indicators and parameters. From sample data presented in table 142, user “Sue01” can have an associated offline status indicator of “Offline, call 123-4567” and an offline status parameter of “9:00-17:00.” User “John01” can have an associated offline status indicator of “On vacation and offline.” and no offline status parameters. User “Bill01” can have an associated offline status indicator of “Sorry honey, driving home” and an offline status parameter including “Wife01.” User “Fred01” can have an associated offline status indicator of “Left early for a party” and an offline status parameter excluding IM user “Boss01.”

For illustrative purposes, assume that Wife01 is logged onto IM client 110, that Boss01 is logged onto IM client 112, and that Joe01 is logged onto IM client 114, each having a contact list established that includes Sue01, John01, BIll01, and Fred01. Also assume that Sue01, John01, BIll01, and Fred01 are currently disconnected from IM server 120.

Wife01, Boss01, and Joe01 each receive a status indicator for Sue01 of “Offline. Call 123-4567” between 9:00-17:00 and otherwise receive a system default indicator provided for an offline IM user. Wife01, Boss01, and Joe01 each receive a status indicator for John01 of “On vacation and offline” instead of a system default. Wife01 receives a status indicator of “Sorry honey, driving home” for Bill01, while Boss01 and Joe01 receive a system default indicator that Bill01 is offline. Boss01 receives a system default indicator that Fred01 is offline, while Wife01 and Joe01 each receive indicator “Left early for a party” for Fred01.

Networks 130 and 132 can include any hardware/software/and firmware necessary to convey data encoded within carrier waves. Data can be contained within analog or digital signals and conveyed though data or voice channels. Networks 130 and 132 can include local components and data pathways necessary for communications to be exchanged among computing device components and between integrated device components and peripheral devices. Networks 130 and 132 can also include network equipment, such as routers, data lines, hubs, and intermediary servers which together form a data network, such as the Internet. Networks 130 and 132 can also include circuit-based communication components and mobile communication components, such as telephony switches, modems, cellular communication towers, and the like. Each of the networks 130 and 132 can include line based and/or wireless communication pathways.

Status repository 140 can be a physical or virtual storage space configured to store digital information. Status repository 140 can be physically implemented within any type of hardware including, but not limited to, a magnetic disk, an optical disk, a semiconductor memory, a digitally encoded plastic memory, a holographic memory, or any other recording medium. Status repository 140 can be a stand-alone storage unit as well as a storage unit formed from a plurality of physical devices. Additionally, information can be stored within status repository 140 in a variety of manners. For example, information can be stored within a database structure or can be stored within one or more files of a file storage system, where each file may or may not be indexed for information searching purposes. Further, status repository 140 can utilize one or more encryption mechanisms to protect stored information from unauthorized access.

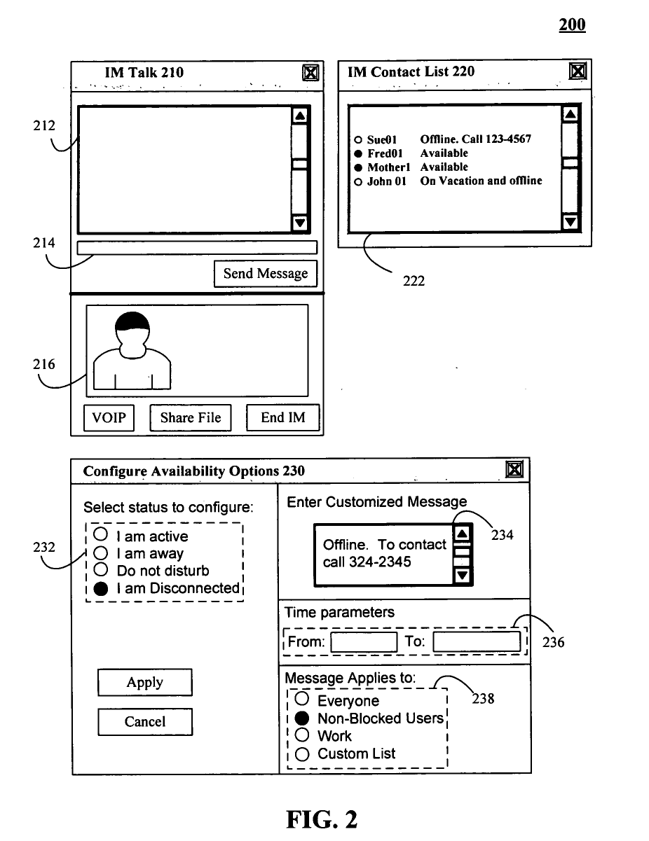

FIG. 2 illustrates IM graphical user interfaces (GUIs) 200 for an IM system having persistent IM status indicators in accordance with an embodiment of the inventive arrangements disclosed herein. GUIs 200 can be interfaces used by IM clients 110-114 of system 100. The invention is not to be construed as limited to the precise arrangements of GUIs 200, however, and any GUI that permits IM communication and that permits status of IM users to be presented can be utilized with the persistent IM status indicators described herein.

GUIs 200 can include IM Talk GUI 210, IM Contact List GUI 220, and Configuration GUI 230. IM Talk GUI 210 can include a dialog section 212, where previously sent textual messages appear. An IM conversation can be reviewed by scrolling though the dialog section 212. Section 214 can be an outgoing message section, where users can type messages, which are sent by clicking a send message button or other message sending trigger. A sent message appears in dialog section 212 and in an equivalent dialog section of any communication participants communicating with the user of IM Talk GUI 210.

IM Talk GUI 210 can optionally include communication options other than text messaging. For example, IM Talk GUI 210 can include a video display section 216, where a live video feed from one or more IM communicators can be presented. IM Talk GUI 210 can have a variety of other communication features, such as a voice over internet protocol (VOIP) communication feature and a file sharing feature.

IM contact list 220 includes a user status section 222 that displays selected IM users and their status indicators. Status indicators can include IM user customized offline status indicators. For example, Sue01 could previously have specified an offline indicator of “Offline. Call 123-4567.” Since Sue01 is offline, this offline status indicator is displayed in user status section 222. Similarly, a configured offline status indicator of “On vacation and offline” can be presented in user status section 222 for John01.

Configuration GUI 230 can be used to select (232) a status indicator. Status indicators can include online indicators, such as “I am active,” “I am away,” and “Do not disturb,” each of which can be customized to display a message written in message section 234. Configuration GUI 230 can also be used to configure an offline indicator by selecting “I am Disconnected” in status indicator section 232. A user created offline status indicator message can be written in message section 234.

GUI 230 can also permit a user to designate one or more offline status parameters. For example, section 236 can be used to specify a time parameter. Section 238 can specify which IM users are to receive a customized offline message (234) and which are to receive a default message. For example, section 238 can specify that everyone is to receive the customized message, that only non-blocked IM users are to receive it, and that users associated with a group “work” are to receive a customized message. An option can also be provided to define a list of included and/or excluded IM users by name.

None of the GUIs 200 (GUI 210, GUI 220, and GUI 230) are to be construed as limited to the precise details and arrangements, shown, but are intended to encompass alternative interface presentation options, visual elements, triggers, and the like. Thus, GUIs 200 are intended to illustrate an interface concept and interface derivatives for implementing the concept shown by GUIs 200 are contemplated.

For example, although shown in a visual context, the GUIs 200 can be implemented for different modalities. For example, each of the GUIs 200 can be implemented as multimodal interfaces. In another example, each of the GUIs 200 can be audible only interfaces used to interface with an IM server via a telephone.

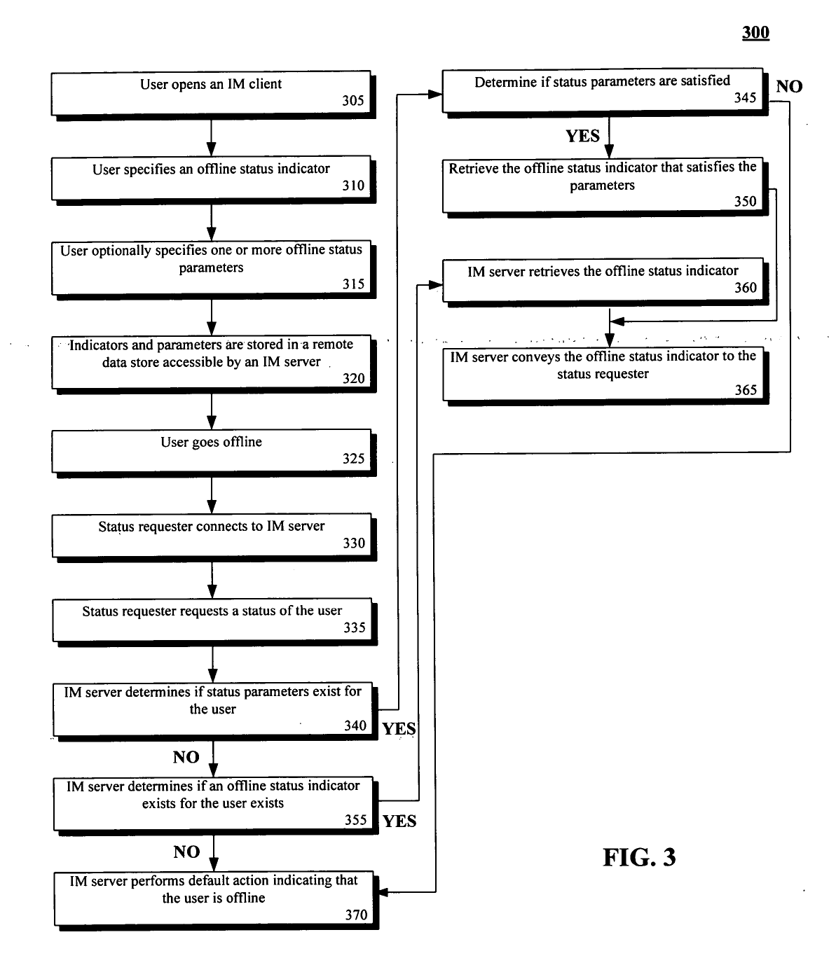

FIG. 3 is a flow chart of a method 300 for implementing persistent IM status indicators in accordance with an embodiment of the inventive arrangements disclosed herein. System 300 can be performed in the context of a system 100.

Method 300 can begin in step 305, where a user opens an IM client. In step 310, the user can specify an offline status indicator that is to be provided to others when that user is disconnected from an IM server. In step 315, the user can optionally specify one or more offline status parameters, which effect when and to whom the offline status indicator is to be provided. In step 320, the indicators and parameters can be stored in a remote data store accessible by an IM server. In step 325, the user can go offline.

In-step 330, a status requester can connect to the IM server. In step 335, the status requester can request a status for one or more users, including the offline user. In step 340, the IM server can determine if one or more status parameters exist for each IM user for whom a status request has been issued. If no such parameters exist, the method can progress to step 355, where the IM server can determine if an offline status indicator exists for the user. If not, the method can progress to step 370, where the IM server can perform a default action that indicates that the user is offline. If status requests have been made for other IM users, the method can loop to step 340 (not shown) where processing tasks for those other IM users can be performed. If no more status requests need processing, no further action needs to be taken in response to the status request, and the method can end.

If in step 340, the IM server determines that a status parameter exists for the user, the method can proceed from step 340 to step 345. In step 345, the IM server can determine if the status parameters are satisfied by current conditions. That is, the IM server can compare constraints or conditions specified in the status parameters against current system values. If an unfavorable comparison results, meaning that the offline status parameters are not satisfied, then the method can proceed from step 345 to step 370. In step 370 a default action can be taken.

If the status parameters are satisfied in step 345, the method can proceed to step 350, where the offline status indicator that satisfies the parameters can be retrieved. It should be noted that multiple different offline status indicators can be stored for a single IM user, each having different parameters. For example, three different offline messages can be established for a single user: one for family contacts, one for business contacts, and one for other contacts. The method can proceed from step 350 to step 365, where an offline status indicator can be conveyed to the status requestor.

If in step 355, the IM server determines an offline status indicator not associated with any status parameters exists, then the method can proceed from step 355 to step 360. In step 360, the IM server can retrieve the offline status indicator and can then progress to step 365. In step 365, the IM server can convey retrieved the offline status indicator to the status requester. If status requests have been made for other IM users, the method can loop to step 340 (not shown) where processing tasks for those other IM users can be performed. If no more status requests need processing, no further action needs to be taken in response to the status request, and the method can end.

The present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. An instant messaging interface comprising:
an offline status indicator that is configurable by a user, wherein the offline status indicator is presented to status requesters seeking a status of the user when the user is offline.

2. The interface of claim 1, wherein the offline status indicator includes a user provided text message.

3. The interface of claim 1, wherein the user configured offline status indicator is stored within an instant messaging server.

4. The interface of claim 1, further comprising:
at least one offline status parameter configurable by the user, wherein the at least one offline status parameter establishes a condition that modifies a manner in which the offline status indicator is presented to at least one of the status requesters.

5. The interface of claim 4, wherein one of the at least one offline status parameters establishes time constraints for presenting the offline status indicator to the status requesters.

6. The interface of claim 4, wherein one of the at least one offline status parameters specifies a set of status requesters to whom the offline status indicator is to be presented, wherein not all potential status requesters are included in the specified set.

7. An instant messaging server comprising:
a status repository including a plurality of user established offline status indicators, each associated with an instant messaging user, wherein the instant messaging server is configured to present one of the user established offline status indicators to status requesters seeking a status of an associated user, whenever the associated instant messaging user is not connected to the instant messaging server.

8. The server of claim 7, wherein at least one of the plurality of user established offline status indicators includes a user provided text message.

9. The server of claim 7, wherein the offline status repository further includes a plurality of offline status parameters, each offline status parameter specifying a condition that modifies a manner in which the offline status indicator is presented to at least one of the status requesters.

10. The server of claim 9, wherein at least a portion of the offline status parameters are specified by an associated instant messaging user.

11. A method for instant messages comprising:
an instant messaging server receiving a status request for a user from a status requester;
the instant messaging server determining that the user is not connected to the instant messaging server;
querying a status repository for an offline status indicator associated with the user; and
responsive to finding an offline status indicator in the querying step, conveying the offline status indicator to the status requester.

12. The method of claim 11, further comprising:
before the querying step, receiving the offline status indicator from the user; and
storing the offline status indicator in the status repository.

13. The method of claim 11, wherein the offline status indicator includes a user provided text message.

14. The method of claim 11, further comprising:
searching the status repository for an offline status parameter associated with the user; and
comparing the offline status parameter with at least one value related to the status request, wherein the querying step is based in part upon results of the comparing step.

15. The method of claim 14, wherein the IM server conveys a default offline status indicator and not the user provided offline status indicator to the status requester when the comparing step indicates that conditions of the offline status parameter are not satisfied.

16. The method of claim 11, further comprising:
before the querying step, receiving a plurality of offline status indicators from the user, each of the plurality of offline status indicators being associated with at least one value related to the status request; and
storing the plurality of offline status indicators in the status repository.

17. The method of claim 16, wherein each of the plurality of offline status indicators includes a user provided text message.

18. The method of claim 16, further comprising:
comparing the values related to the status request with the plurality of offline status indicators; and
based upon the comparing step, selecting a particular one of the associated offline indicators in the querying step.

19. The method of claim 18, further wherein each of the plurality of offline status indicators includes a different user provided text message.

20. The method of claim 11, wherein said steps of claim 11 are performed by at least one machine in accordance with at least one computer program having a plurality of code sections that are executable by the at least one machine.
